(19) United States
(12) Patent Application Publication
(10) Pub. No.: US 2015/0244800 A1
(43) Pub. Date: Aug. 27, 2015

(54) DISPLAY APPARATUS THAT DISPLAYS A SCREEN SYNCHRONIZED WITH A SCREEN OF ANOTHER APPARATUS

(71) Applicant: TOSHIBA TEC KABUSHIKI KAISHA, Tokyo (JP)

(72) Inventors: Akihiro MIZUTANI, Mishima Shizuoka (JP); Takahiro HAGIWARA, Chiba Chiba (JP); Shinji MAKISHIMA, Suntou Shizuoka (JP); Toshihiro IDA, Mishima Shizuoka (JP); Yusuke HAMADA, Mishima Shizuoka (JP); Hiroshi WATANABE, Yokohama Kanagawa (JP); Ken SAKUTA, Izunokuni Shizuoka (JP)

(21) Appl. No.: 14/626,798

(22) Filed: Feb. 19, 2015

(30) Foreign Application Priority Data
Feb. 21, 2014 (JP) 2014-032059

(51) Int. Cl. H04L 29/08; G06F 3/0484

(52) U.S. Cl. CPC H04L 67/1095; G06F 3/04847

(57) ABSTRACT

A display apparatus includes a display unit, a communication unit configured to periodically receive synchronization information for synchronizing a screen of the display unit with a screen of another display apparatus, and a control unit configured to control the display unit to display a first screen corresponding to the received synchronization information when the control unit is not carrying out a predetermined operation, and a second screen that does not correspond to the synchronization information when the control unit is carrying out the predetermined operation.

### CROSS-REFERENCE TO RELATED APPLICATION

This application is based upon and claims the benefit of priority from Japanese Patent Application No. 2014-032059, filed Feb. 21, 2014, the entire contents of which are incorporated herein by reference.

### FIELD

Embodiments described herein relate generally to a display apparatus that displays a screen synchronized with a screen of another display apparatus.

### BACKGROUND

In the related art, a system (electronic distribution system) is capable of synchronizing screens displayed on a plurality of terminal devices. In such a system, for example, “presenter,” “viewer,” or another role is allocated to each of the terminal devices. A screen of a terminal device having a role of “viewer” follows a screen of a terminal having a role of “presenter.”

However, as the screen of the terminal device having the role of “viewer” is synchronized with the terminal device having the role of “presenter,” the screen of the viewer's terminal device may be changed when an operator of the viewer's terminal device is not ready to move to the next screen.

### DESCRIPTION OF THE DRAWINGS

FIG. 1 illustrates an electronic distribution system including a browsing terminal according to an embodiment.

FIG. 2 illustrates the browsing terminal according to an embodiment.

FIG. 3 is a flow chart illustrating a process carried out by the browsing terminal according to the embodiment.

### DETAILED DESCRIPTION

An embodiment provides a browsing terminal and a program therefor with high convenience.

In general, according to one embodiment, a display apparatus includes a display unit, a communication unit configured to periodically receive synchronization information for synchronizing a screen of the display unit with a screen of another display apparatus, and a control unit configured to control the display unit to display a first screen corresponding to the received synchronization information when the control unit is not carrying out a predetermined operation, and a second screen that does not correspond to the synchronization information when the control unit is carrying out the predetermined operation.

Hereinafter, a browsing terminal and a program therefor according to an embodiment will be described in detail.

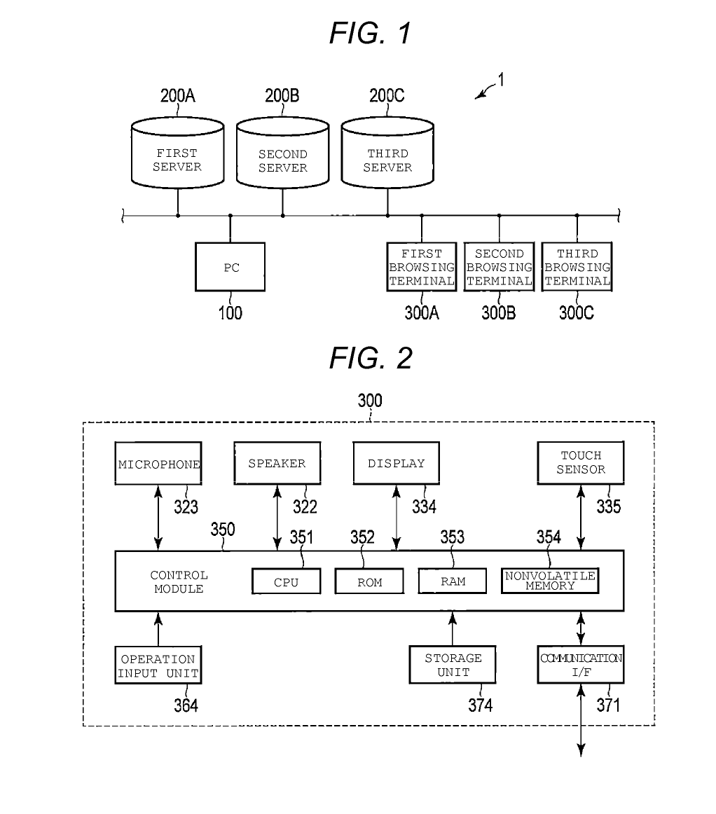

FIG. 1 illustrates an example of an electronic distribution system 1. The electronic distribution system 1 includes a PC 100, a server 200, a browsing terminal 300, and the like.

The electronic distribution system 1 includes a first server 200A, a second server 200B, a third server 200C, and the like, as the server 200. When it is not necessary to distinguish among the first server 200A, the second server 200B, and the third server 200C, each of the servers is generally referred to as the server 200.

Further, the electronic distribution system 1 includes a first browsing terminal 300A, a second browsing terminal 300B, a third browsing terminal 300C, and the like as the browsing terminal 300. When it is not necessary to distinguish among the first browsing terminal 300A, the second browsing terminal 300B, and the third browsing terminal 300C, each of the browsing terminals is generally referred to as the browsing terminal 300.

Here, an example in which the electronic distribution system 1 includes the first browsing terminal 300A, the second browsing terminal 300B, and the third browsing terminal 300C as the browsing terminal 300 is described, but it is sufficient if two or more the browsing terminal 300 are provided.

The PC 100, the server 200, and the browsing terminal 300 are connected to each other through a network. That is, the PC 100 and the server 200 may mutually transmit or receive data. Further, the server 200 and the browsing terminal 300 may mutually transmit or receive data. The network may be a LAN, the Internet, a wireless communication network, or the like.

The PC 100 is a typical computer. The PC 100 includes a communication I/F, a storage unit, a control unit, and the like. The communication unit may perform communication with other devices on the network. The storage unit may store document data. The control unit may operate to store the document data readout from the storage unit in the server 200. That is, the PC 100 may upload the document data to the server 200 through the network (for example, the first server 200A).

The document data is in a PDF format, a PNG (portable network graphics) format, or the like, and has plural pages for display. The document data includes a specific ID (document ID). Further, the document data includes a page ID for each page. That is, on a terminal that displays a document image of the document data, a page in the document data to be displayed may be specified based on the document ID and the page ID.

The server 200 includes a communication unit, a storage unit, and a control unit. The communication unit may perform communication with other devices on the network. The storage unit may store document data and other various data. The control unit may store the document data uploaded from the PC 100 in the storage unit. Further, the control unit may distribute the document data to the browsing terminal 300. In addition, the control unit may communicate with the browsing terminal 300 to acquire display state information (processing state information) indicating a display state (processing state) of the browsing terminal 300.

In this example, the first server 200A stores the document data uploaded from the PC 100.

Further, the second server 200B distributes the document data uploaded to the first server 200A to the browsing terminal 300. The second server 200B may identify document data to be distributed to the browsing terminal 300 according to identification information (terminal ID) of each browsing terminal 300. For example, the second server 200B retains conference information in which a conference ID, conference date and time, a conference title, a document ID, a terminal ID of the browsing terminal 300 owned by a participant, and the like are correlated with each other. The second server 200B acquires the terminal ID from the browsing terminal 300, and refers to the conference information correlated with the acquired terminal ID. The second server 200B may read document data of the document ID correlated with the referenced conference information from the first server 200A, and may distribute the read document data to the browsing terminal 300.

Further, the third server 200C performs communication with each browsing terminal 300 and acquires display state information. The display state information includes information (role information) indicating the terminal ID of the browsing terminal 300 and the role of the browsing terminal 300, the document ID of the document data displayed on the browsing terminal 300, and the page ID indicating the page of the displayed document data. The third server 200C may recognize the document data and a page displayed by each browsing terminal 300 by acquiring the display state information from each browsing terminal 300. Other display state information includes page change, document change, pen addition, pointer synchronization, and the like.

Furthermore, the third server 200C compares the display state information of the browsing terminal 300 of which role is “presenter” with the display state information of the browsing terminal 300 of which role is “viewer.” As a comparison result, when the pieces of display state information are not consistent, the third server 200C transmits synchronization information to the browsing terminal 300 of which role is “viewer.” Further, the third server 200C may transmit the synchronization information to the browsing terminal 300 of which role is “viewer” at a predetermined cycle without performing the comparison.

The synchronization information includes document ID and page ID. The synchronization information is generated based on the document ID and the page ID of the display state information of the browsing terminal 300 of which role is “presenter.” That is, the document ID and the page ID of the synchronization information are consistent with the document ID and the page ID of the display state information of the browsing terminal 300 of which role is “presenter.”

The browsing terminal 300 is a portable phone terminal, a tablet PC, a portable music player, or other electronic devices, for example. The browsing terminal 300 transmits the terminal ID to the second server 200B. As a result, the browsing terminal 300 may receive the document data from the second server 200B. The browsing terminal 300 may receive the received document data.

Further, the browsing terminal 300 may open the received document data. Thus, the browsing terminal 300 may display an arbitrary page of the document data. In addition, the browsing terminal 300 may generate display state information based on the terminal ID of the browsing terminal 300, the role information of the browsing terminal 300, the document ID of the document data displayed by the browsing terminal 300, and the page ID indicating the page of the displayed document data. Furthermore, the browsing terminal 300 performs polling (communication) to the third server 200C at a predetermined cycle or at an arbitrary timing. The browsing terminal 300 transmits the display state information to the third server 200C through the polling. Thus, the third server 200C may sequentially recognize the display state of the browsing terminal 300. Further, the third server 200C may generate the synchronization information based on the display state information received from the browsing terminal 300 of which role is “presenter.”

The browsing terminal 300 of which role is “viewer” receives the synchronization information from the third server 200C. When receiving the synchronization information, the browsing terminal 300 may display the page corresponding to the page ID of the document data corresponding to the document ID indicated by the received synchronization information. That is, the browsing terminal 300 of which role is “viewer” may synchronize the display state thereof with the display state of the browsing terminal 300 of which role is “presenter.”

FIG. 2 illustrates an example of the browsing terminal 300 according to an embodiment.

The browsing terminal 300 includes a control module 350, an operation input unit 364, a communication I/F 371, and a storage unit 374. Further, the browsing terminal 300 includes a presenter 322, a microphone 323, a display 334, and a touch sensor 335.

The control module 350 functions as a control unit that controls operations of the respective units of the browsing terminal 300. The control module 350 includes a CPU 351, a ROM 352, a RAM 353, a nonvolatile memory 354, and the like. The control module 350 performs various processing based on an operation signal supplied from the operation input unit 364 or the touch sensor 335.

The CPU 351 includes an arithmetic element or the like that executes various arithmetic operations. The CPU 351 achieves various functions by executing a program stored in the ROM 352, the nonvolatile memory 354, or the like.

The ROM 352 stores a program for controlling the browsing terminal 300, a program for achieving various functions, or the like. The CPU 351 starts the program stored in the ROM 352 based on the operation signal supplied from the operation input unit 364. As a result, the control module 350 controls the operations of the respective units.

The RAM 353 functions as a work memory of the CPU 351. That is, the RAM 353 stores an arithmetic result of the CPU 351, data read by the CPU 351, or the like.

The nonvolatile memory 354 is a nonvolatile memory that stores various setting information, programs, or the like.

Further, the CPU 351 may execute various processing based on data such as an application stored in the storage unit 374. The control module 350 generates a video signal such as various screens according to the application executed by the CPU 351 to be displayed on the display 334. A process for displaying the document data on the display 334 by the control module 350 corresponds to a document data processing unit. Further, the control module 350 generates an audio signal such as various sound according to the application executed by the CPU 351 to be output through the presenter 322.

The presenter 322 reproduces sound based on the supplied audio signal.

The microphone 323 is a sound collection unit that generates a signal (recording signal) based on external sound of the browsing terminal 300. The microphone 323 supplies the recording signal to the control module 350.

The display 334 is a display device that includes a display panel including plural pixels that are disposed in a matrix form, for example. The display 334 displays a video image based on the video signal.

The touch sensor 335 generates an operation signal based on an electrostatic capacitance type sensor, a pressure reduction type sensor, a thermo sensor, or other methods. For example, the touch sensor 335 is integrally provided with the display 334. Thus, the touch sensor 335 generates an operation signal based on an operation on a screen displayed on the display 334 to be supplied to the control module 350.

The operation input unit 364 includes keys that generate an operation signal according to an operation input by a user, for example. The operation input unit 364 includes, for example, a sound volume setting key for setting sound volume, a luminance setting key for setting display luminance of the display 334, a power key for switching a power state of the browsing terminal 300, and the like. The operation input unit 364 generates an operation signal according to the key operation, and supplies the operation signal to the control module 350.

Further, the operation input unit 364 may further include a track ball that detects a rotational movement. The track ball generates an operation signal according to the rotational movement. Further, the operation input unit 364 may further include a gyro sensor that detects inclination, acceleration, and the like of the browsing terminal 300. The gyro sensor generates an operation signal based on the inclination, acceleration, and the like.

Further, the operation input unit 364 may receive an operation signal from a keyboard, a mouse, or other input devices capable of generating the operation signal. For example, when the browsing terminal 300 includes a USB terminal, a Bluetooth® module or the like, the operation input unit 364 receives an operation signal from an input device connected through the USB terminal or the Bluetooth module, and supplies the operation signal to the control module 350.

The communication I/F 371 may perform communication with other devices on the network. Thus, the browsing terminal 300 may perform communication with the PC 100 and the server 200 connected to the network. Further, the communication I/F 371 may directly perform communication with the PC 100 and the server 200 without using the network.

In addition, the browsing terminal 300 includes a power supply unit (not illustrated). The power supply unit includes a battery, and a terminal (for example, DC jack) for connection with an adapter that receives power from a commercial power supply or the like. The power supply unit charges the battery with the power received from the commercial power supply. Further, the power supply unit supplies the power charged in the battery to the respective units in the browsing terminal 300.

The storage unit 374 includes a hard disk drive (HDD), a solid state drive (SSD), a semiconductor memory, or the like. The storage unit 374 may store a program and an application executed by the CPU 351 of the control module 350, various data, and the like.

The storage unit 374 stores an operating system (OS), and various applications capable of being executed on the OS, for example. The storage unit 374 includes an application (document viewer) for opening the document data, for example.

The control module 350 may open the above-mentioned document data by executing the document viewer. The control module 350 may generate a video signal according to the document data to be displayed on the display 334. Also, the control module 350 may display an arbitrary page of the received document data on the display 334. Further, the control module 350 may acquire the document ID of the document data displayed by the document viewer, and the page ID of the displayed page.

When executing the document viewer, the control module 350 may change the role of the terminal between “presenter” and “viewer.” Further, the control module 350 may generate role information based on the roll of the terminal. In addition, the browsing terminal 300 may store the terminal ID of the terminal in any one of the storage unit 374, the RAM 353, the nonvolatile memory 354, and the like. When there is no change in the display state, the browsing terminal 300 may read the display state information from the memory, and may transmit the information to the third server 200C.

Further, the control module 350 may generate display state information based on the terminal ID of the terminal, the role information of the browsing terminal 300, the document ID of the document data displayed by the browsing terminal 300, and the page ID indicating the page of the displayed document data. The control module 350 transmits the generated display state information to the third server 200C. Further, the control module 350 may store the generated display state information in the storage unit 374, the RAM 353, the nonvolatile memory 354 or the like.

When the role of the browsing terminal 300 is “viewer, ” the control module 350 may execute synchronization processing for synchronizing the display state of the terminal with the display state of the browsing terminal 300 of which roll is “presenter.” For example, when the role of the browsing terminal 300 is “viewer,” and when the synchronization information is received from the third server 200C, the control module 350 may display the page corresponding to the page ID of the document data corresponding to the document ID indicated by the synchronization information on the display 334 by the document viewer. By performing the synchronization processing, the browsing terminal 300 of which role is “viewer” may follow the display state of the browsing terminal 300 of which role is “presenter.”

The control module 350 may execute various predetermined processing according to an operation input while the document viewer is being executed. The predetermined processing includes writing to a private note or a shared note, touch to the display 334 (mouse-down), display screen enlargement (pinch out), or the like. The control module 350 may determine whether the control unit performs the predetermined processing based on the display state to the display 334, the operation signal or the like.

The control module 350 may display a transparent layer (note) overlapped on the document of the document data. Further, the control module 350 may operate to draw an image based on an input operation signal input with respect to the note. For example, the control module 350 may draw a track of coordinate information input by the touch sensor 335 with respect to the note as an image. That is, the control module 350 may perform additional recording with respect to the document data by drawing the image with respect to the note.

Further, the control module 350 may generate drawing information based on the note where the image is drawn. The drawing information refers to information for drawing an image on the document data. For example, the drawing information indicates the track of the coordinates where the operation is input as described above. The control module 350 may display the image based on the drawing information overlapped on the document. The control module 350 may switch the display and non-display of the image based on the drawing information.

The note includes the private note and the shared note as described above. The private note refers to a layer for inputting additional images through one browsing terminal 300. Further, the shared layer refers to a layer for sharing additional images among the plural browsing terminals 300. The control module 350 may switch the private note and the shared note. In addition, the control module 350 may individually generate the drawing information for the private note and the shared note, respectively. Furthermore, the control module 350 may individually switch the display and non-display of the drawing information in the private note and the shared note, respectively.

Further, the control module 350 may add the drawing information generated based on the shared note (shared drawing information) to the display state information. Thus, the control module 350 may transmit the shared drawing information to the third server 200C. The control module 350 may limit image addition to the shared note according to the role of the terminal. For example, the control module 350 may allow writing to the shared note only when the role of the terminal is “presenter.”

When receiving the shared drawing information from the browsing terminal 300, the third server 200C adds the received shared drawing information to the synchronization information. Thus, the third server 200C may share the shared drawing information among the plural browsing terminals 300.

Further, when receiving the shared drawing information from the plural browsing terminals 300, the third server 200C integrates the plural pieces of shared drawing information into one piece of shared drawing information. The third server 200C may add the integrated shared drawing information to the synchronization information. Thus, the third server 200C may share, in a state where the shared drawing information supplied from the plural browsing terminals 300 is integrated, the shared drawing information among the plural browsing terminals 300.

In addition, the server 200 may create image-added document data acquired by integrating the shared drawing information with the document data. The browsing terminal 300 may request the server 200 to download the image-added document data where the drawing information of the note is reflected. The server 200 transmits the image-added document data to the browsing terminal 300 according to the request from the browsing terminal 300.

Furthermore, when requesting the server 200 to download the image-added document data, the browsing terminal 300 may transmit the drawing information of the private note to the server 200. The server 200 may create the image-added document data acquired by integrating the drawing information of the private note and the shared drawing information with the document data. The server 200 transmits the image-added document data to the browsing terminal 300 according to the request from the browsing terminal 300.

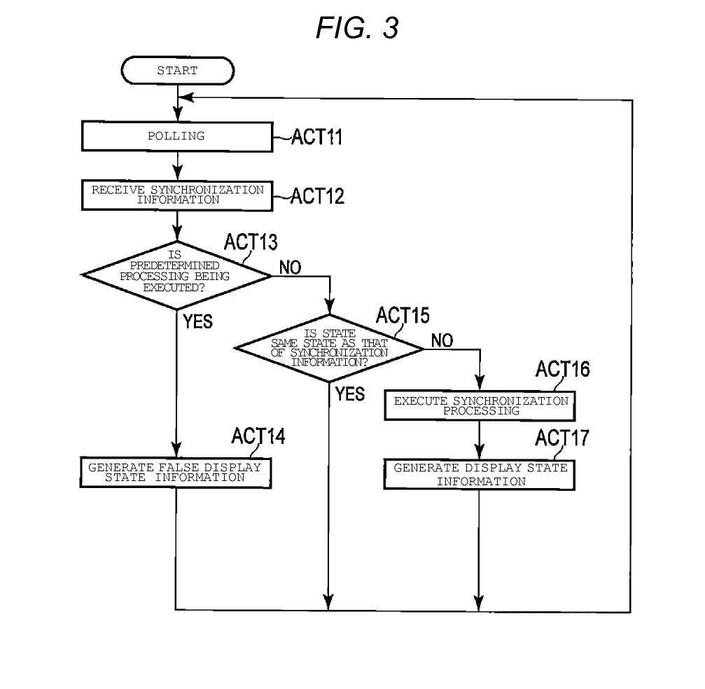

FIG. 3 illustrates an example of processing of the browsing terminal 300 of which role is “viewer.” In this example, it is assumed that the role of the first browsing terminal 300A is “presenter,” and the role of the second browsing terminal 300B and the third browsing terminal 300C is “viewer.” Since processing of the second browsing terminal 300B and processing of the third browsing terminal 300C are the same, an example of the processing of the second browsing terminal 300B will be described.

The control module 350 of the second browsing terminal 300B performs polling to the third server 200C (Act 11). Through this process, the second browsing terminal 300B transmits the display state information thereof to the third server 200C.

Then, the control module 350 of the second browsing terminal 300B receives synchronization information from the third server 200C (Act 12). Through this process, the second browsing terminal 300B may recognize the display state of the first browsing terminal 300A of which role is “presenter.”

When receiving the synchronization information, the control module 350 of the second browsing terminal 300B determines whether predetermined processing is being executed (Act 13). That is, the second browsing terminal 300B determines whether the second browsing terminal 300B executes processing that is set as the predetermined processing in advance.

When determining that the predetermined processing is being executed in Act 13, the control module 350 of the second browsing terminal 300B generates false display state information without performing the synchronization processing (Act 14), and returns to Act 11. That is, the second browsing terminal 300B transmits the false display state generated in Act 14 to the third server 200C. That is, when it is determined that the predetermined processing is being executed in Act 13, the control module 350 of the second browsing terminal 300B limits the synchronization processing.

The false display state information includes a terminal ID, role information, a document ID, a page ID, and the like. The second browsing terminal 300B sets the document ID and the page ID of the synchronization information received from the third server 200C in Act 12 to generate the document ID and the page ID of the false display state information. That is, the false display state information includes the same document ID and page ID as those of the synchronization information. That is, the control module 350 of the second browsing terminal 300B transmits information indicating that the display state (processing state) of the terminal is synchronized with the first browsing terminal 300A based on the synchronization information, to the third server 200C.

According to this method, the second browsing terminal 300B may maintain the display state thereof when executing the predetermined processing. Further, the second browsing terminal 300B may cause the third server 200C to recognize that the second browsing terminal 300B is following the display state of the first browsing terminal 300A.

Further, when it is determined in Act 13 that the predetermined processing is not being executed, the control module 350 of the second browsing terminal 300B determines whether the state of the terminal is the same state as that of the synchronization information (Act 15). When the document data corresponding to the document ID indicated by the received synchronization information is opened and the page corresponding to the page ID indicated by the synchronization information is displayed, the control module 350 of the second browsing terminal 300B determines that the terminal is in the same state as that of the synchronization information.

When it is determined in Act 15 that the terminal unit is in the same state as that of the synchronization information, since the synchronization processing is not necessary, the control module 350 of the second browsing terminal 300B returns to Act 11. In this case, the second browsing terminal 300B transmits display state information that is finally generated to the third server 200C.

When it is determined in Act 15 that the control unit is not in the same state as that of the synchronization information, the control module 350 of the second browsing terminal 300B executes the synchronization processing (Act 16). In this case, the control module 350 of the second browsing terminal 300B displays the page corresponding to the page ID indicated by the synchronization information of the document data corresponding to the document ID indicated by the synchronization information received in Act 12, on the display 334.

Further, the control module 350 of the second browsing terminal 300B generates display state information based on the display state of the terminal after performing the synchronization processing (Act 17), and then, returns to Act 11. In this case, in the display state information, the synchronization information, and the document ID and the page ID are consistent. That is, the second browsing terminal 300B transmits the display state information generated in Act 17 to the third server 200C.

According to the above configuration, even in a state where the browsing terminal 300 of which role is “viewer” is synchronized with the browsing terminal 300 of which role is “presenter” while the predetermined processing is being executed, the browsing terminal 300 of which role is “viewer” may avoid the synchronization processing. Thus, the browsing terminal 300 may prevent the display state from being changed by the synchronization processing while the predetermined processing is being executed. As a result, it is possible to provide a browsing terminal and a program therefor with high convenience.

In the above exemplary embodiment, the browsing terminal 300 performs the polling with respect to the third server 200C at a predetermined cycle or at an arbitrary timing, but the exemplary embodiment is not limited to this configuration. The browsing terminal 300 may generate new display state information when the predetermined processing is terminated, and may perform the polling with respect to the third server 200C. Thus, the browsing terminal 300 may synchronize the display state thereof with the browsing terminal 300 that is the “presenter” immediately after the predetermined processing is terminated.

Further, when the synchronization information is received from the third server 200C while the predetermined processing is being executed, the browsing terminal 300 of which role is “viewer” may store the received synchronization information in a memory such as the storage unit 374, the RAM 353, or the nonvolatile memory 354. According to this configuration, when the predetermined processing is terminated, the browsing terminal 300 may read the synchronization information from the memory, and may perform the synchronization processing using the read synchronization information. Thus, the browsing terminal 300 may synchronize the display state thereof with the browsing terminal 300 that is the “presenter” immediately after the predetermined processing is terminated.

Further, in the exemplary embodiment, a configuration in which the predetermined processing corresponds to the writing to the private note or the shared note, the mouse-down, the pinch out or the like is described, but the exemplary embodiment is not limited to this configuration. The predetermined processing may be any processing. For example, the predetermined processing may be a printing instruction, downloading of image-added document data, or the like.

The functions described in the above-described embodiment are not limited to the configuration using hardware, and may be achieved by causing a computer to read a program where the respective functions are written using software. Further, the respective functions may be configured by appropriately selecting any one of software and hardware.

In the exemplary embodiment, a case where the functions for achieving the exemplary embodiment are stored in the apparatus in advance is described, but the exemplary embodiment is not limited thereto, and the same functions may be downloaded to the apparatus from a network, or the same functions may be stored in a recording medium to be installed to the apparatus. The recording medium may be any type of recording medium that is capable of storing a program and is readable by the apparatus, such as a CD-ROM. Further, the functions obtained by such installation or downloading in advance may be achieved in cooperation with an operating system (OS) or the like in the apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display apparatus comprising:
a display unit;
a communication unit configured to periodically receive synchronization information for synchronizing a screen of the display unit with a screen of another display apparatus; and
a control unit configured to control the display unit to display a first screen corresponding to the received synchronization information when the control unit is not carrying out a predetermined operation, and a second screen that does not correspond to the synchronization information when the control unit is carrying out the predetermined operation.

2. The display apparatus according to claim 1, wherein
the synchronization information includes a document identification code and a page identification code, and
the display unit displays, as the screen, a page of a document corresponding to the document identification code and the page identification code included in the received synchronization information.

3. The display apparatus according to claim 1, further comprising:
an operation unit configured to receive a user input, wherein
the predetermined operation is carried out when the operation unit receives a predetermined user input.

4. The display apparatus according to claim 3, wherein
the predetermined user input includes an input of an image on the screen displayed on the display unit.

5. The display apparatus according to claim 1, wherein
the control unit is further configured to control the communication unit to periodically transmit display state information about the screen displayed on the display unit, and
the communication unit transmits, as the display state information, information about a screen that corresponds to the received synchronization information, when the display unit displays the second screen.

6. The display apparatus according to claim 5, wherein
the control unit controls the communication unit to transmit the display state information every predetermined period of time.

7. The display apparatus according to claim 1, further comprising:
a storage unit, wherein
the control unit is further configured to control the storage unit to store the synchronization information that is received while display unit displays the second screen.

8. The display apparatus according to claim 7, wherein
the control unit controls the display unit to display the first screen corresponding to the stored synchronization information after the control unit terminates the predetermined operation.

9. A method for displaying information on a display unit of a display apparatus comprising:
periodically receive synchronization information for synchronizing a screen of the display unit with a screen of another display apparatus;
displaying, on the display unit, a first screen corresponding to the synchronization information when the display apparatus is not carrying out a predetermined operation; and
displaying, on the display unit, a second screen that does not correspond to the synchronization information when the display apparatus is carrying out a predetermined operation.

10. The method according to claim 9, wherein
the synchronization information includes a document identification code and a page identification code, and
as the first screen, a page of a document corresponding to the document identification code and the page identification code included in the received synchronization information is displayed.

11. The method according to claim 9, further comprising:
receiving a user input, wherein
the predetermined operation is carried out when a predetermined user input is received.

12. The method according to claim 11, wherein
the predetermined user input includes an input of an image on the screen displayed on the display unit.

13. The method according to claim 9, further comprising:
periodically transmitting display state information about the screen displayed on the display unit, wherein
as the display state information, information about a screen that corresponds to the received synchronization information is transmitted, when the display unit displays the second screen.

14. The method according to claim 13, wherein
the display state information is transmitted every predetermined period of time.

15. The method according to claim 9, further comprising:
storing the synchronization information while display unit displays the second screen.

16. The method according to claim 15, further comprising:
displaying the first screen corresponding to the stored synchronization information after the control unit terminates the predetermined operation.

17. A non-transitory computer readable medium comprising a program that is executable in a computing device to cause the computing device to perform a method for displaying information on a display unit, the method comprising:
periodically receive synchronization information for synchronizing a screen of the display unit with a screen of another display apparatus;
displaying, on the display unit, a first screen corresponding to the synchronization information when the display apparatus is not carrying out a predetermined operation; and
displaying, on the display unit, a second screen that does not correspond to the synchronization information when the display apparatus is carrying out a predetermined operation.
